(19) United States
(12) Patent Application Publication
(10) Pub. No.: US 2006/0015855 A1
(43) Pub. Date: Jan. 19, 2006

(54) Systems and methods for replacing NOP instructions in a first program with instructions of a second program

(76) Inventor: Danny N. Kumamoto, Cedar Park, TX (US)

Correspondence Address: LAW OFFICES OF MARK L. BERRIER, 1250 CAPITAL OF TEXAS HIGHWAY, SOUTH, BUILDING II, SUITE 216, AUSTIN, TX, 78746, US

(21) Appl. No.: 10/890,088

(22) Filed: Jul. 13, 2004

(51) Int. Cl. G06F 9/45

(52) U.S. Cl. 717/136

(57) ABSTRACT

Systems and method for replacing NOP instructions in a first program with instructions from a second program to enable execution of the second program during execution of the first program without requiring any additional processing resources. Execution of the two programs is accomplished without switching execution contexts and without causing any interference with the execution of the first program. In one embodiment, all processing resources are available to the first program, and are only used to execute the second program if they are unused by the first program. In another embodiment, a small amount of resources could be allocated to the second program. The replacement of the NOP instructions may be performed at compile-time, at run-time, or at some intermediate time, and may be performed by a compiler, a processor, or various other tools.

### BACKGROUND OF THE INVENTION

1. Field of the invention

The present invention relates generally to systems and methods for optimizing the execution of instructions by a processor. More particularly, the present invention relates to systems and methods for replacing NOP instructions in a first program with processor instructions from a second program, enabling the execution of the second program during the execution of the first program without using additional processing resources.

2. Related art

Non-pipelined processors process only one processor instruction at a time. In other words, the execution of one instruction must be completed before execution of another instruction can begin. Thus, if a non-pipelined processor includes five execution stages, an instruction must complete all five stages before the next instruction in the instruction stream can enter the first execution stage of the processor. Each of the processor's execution stages is therefore idle—and unutilized—for four out of five clock cycles (assuming one clock cycle per execution stage). Pipelined processing attempts to increase processing efficiency by introducing a new instruction into the first stage of the processor on every clock cycle. As one instruction advances to the second stage after completing execution at the first stage, the first stage becomes available for a new instruction.

Accordingly, pipelined processors can potentially accept a new instruction from the instruction stream on every clock cycle. As a result, at any given time, the processor can be executing as many as five instructions (assuming a five-stage processor), with each of the five instructions being at a different execution stage. Thus, a pipelined, five-stage processor potentially can have five times the throughput of a non-pipelined, five-stage processor. Various constraints, however, prevent pipelined processors from reaching this potential increase in throughput.

Often, the execution of one instruction depends on a result obtained by the execution of a preceding instruction. Consequently, the execution of an instruction may need to be delayed by the number of clock cycles it would take to complete execution of the preceding instruction. To ensure proper spacing between the two instructions, a compiler typically generates and inserts between the instructions the right number of no-operation (NOP) instructions. NOP instructions do not perform any useful processing. Instead, NOP instructions simply occupy slots in the program that cannot be occupied by useful instructions. As a result, the inclusion of NOP instructions, though necessary, reduces the throughput of a pipelined processor. The actual throughput of a pipelined processor is thus somewhere between the throughput of a non-pipelined processor and the desired theoretical maximum throughput.

Compilers can apply different types of optimization algorithms in an effort to reduce the number of NOP instructions and thus reduce the amount of wasted processing resources. One such optimization algorithm, for example, involves increasing the spacing between dependent instructions in an instruction stream by rearranging the instructions' execution order. Optimization, however, typically can only reduce, but not eliminate, the number of NOP instructions in the instruction stream.

Typically, the number of necessary NOP instructions in an instruction stream increases as the depth of (number of stages in) a processor's pipeline increases. The deeper the pipeline, the greater the number of clock cycles a dependent instruction may need to wait before the result required by the instruction is computed. For example, if the depth of a pipeline is five stages, a subsequent instruction that depends on the result of a preceding instruction must follow the preceding instruction by at least five positions in the instruction stream. If the intervening positions cannot be filled with useful instructions, the positions are filled with NOP instructions. In this example, up to five NOP instructions may be inserted to ensure that the result of the first instruction is available for execution of this second instruction.

NOP instructions may be used even more frequently in very long instruction word (VLIW)-type processors. VLIW-type processors have two or more processors that operate in parallel, so a VLIW instruction word includes an instruction for each of these processors. Since, typically, each of the instructions in the instruction word is of a different type, it becomes more difficult for optimizers to find regular instructions with which to replace NOP instructions. The greater the breadth of a VLIW-type processor, the greater the probability that it will not be possible to replace a NOP instruction will not get replaced.

There is therefore a need for systems and methods that can make use of the processing resources that are unused because of that presence of NOP instructions in the instruction stream(s). The need for such systems and methods is even greater for VLIW-type processors, which typically require the use of more NOP instructions.

### SUMMARY OF THE INVENTION

One or more of the problems outlined above may be solved by the various embodiments of the invention. Broadly speaking, the invention includes systems and methods for replacing NOP instructions in a first program with instructions from a second program, thereby enabling execution of the second set of instructions during execution of the first set of instructions without using any additional processing resources.

In one embodiment, execution of the second set of processor instructions does not use any processing resources that are usable by the first set of processor instructions. The execution may be accomplished, for example, without switching execution contexts (which would delay execution of the first set of processor instructions) and without using registers that would be usable by the first set of processor instructions (which would interfere with the execution of the first set of processor instructions).

In another embodiment, certain resources, such as one or more processor registers, may be exclusively allocated to the execution of the second set of instructions thus preventing the second set of instructions from taking those types of resources from the first set of instructions.

In one embodiment, if only limited processing resources are available to the second set of processor instructions, one or more restrictions may be imposed on the choice of the second program. For example, the second program may be restricted to: programs having program instructions that are mostly independent of each other; programs having small code size; programs having a small and limited state machine; programs for which the majority of processing can be performed in a single routine; or programs whose execution requires only a small number of registers. Data integrity check program, security check programs, processor diagnostic programs, system diagnostic programs, data encryption/decryption programs, and data compression/decompression programs are some examples of such programs.

The replacing of the NOP instructions may be performed at different times in different embodiments. For example, the replacing of the NOP instructions may be performed by a compiler during compilation of the first and second set of processor instructions. Alternatively, the replacement of the NOP instructions may be performed by a processor after the processor receives the compiled processor instructions for the first and second programs.

In other embodiments, the replacing may be performed after compilation and before execution of the instructions. In this case, the replacement of the NOP instructions may be performed manually or by using a tool that is specifically configured to perform the replacements. In still other embodiments, the replacing may be performed in multiple stages. Additionally, the NOP instructions may be replaced with instructions from more than one program.

An alternative embodiment of the invention comprises a method for replacing NOP instructions in a first program. In one embodiment, the NOP instructions of the first program may be replaced with instructions from a second program. This enables execution of the second program in place of the NOP instructions during execution of the first program. The second program is therefore executed using only the processing resources that are unused by the first program.

Another alternative embodiment of the invention comprises a tool configured to receive a first program and a second program, and to replace NOP instructions in the first program with instructions from the second program, thus enabling execution of the second set of processor instructions during the execution of the first program.

Yet another alternative embodiment of the invention comprises a computer program product. The computer program product comprises a computer readable medium that stores software code which is effective to receive a first program and a second program, and to replace NOP instructions in the first program with instructions from the second program, thus enabling execution of the second program during the execution of the first program.

Numerous additional embodiments are also possible.

The various embodiments of the present invention may provide a number of advantages over the prior art. Resources which would otherwise be wasted by processing NOP instructions are instead utilized by replacing the NOP instructions in the first program with useful instructions from the second program. In at least some of the embodiments, the instructions of the second program are thereby executed without interfering with the execution of the first program. In at least some of the embodiments, no special resources are required by a processor to execute the combined instruction stream which is produced by replacing NOP instructions in the first program with introductions from the second program.

### BRIEF DESCRIPTION OF THE DRAWINGS

Other objects and advantages of the invention may become apparent upon reading the following detailed description and upon reference to the accompanying drawings.

FIG. 1A is a block diagram illustrating the processing sequence of a first set of instructions—which includes dependent instructions—by a pipelined processor in accordance with one embodiment;

FIG. 1B is a block diagram illustrating the insertion of NOP instructions into the instruction stream of a pipelined processor in accordance with one embodiment;

FIG. 2 is a table illustrating the inclusion of NOP instructions into the instruction streams of a VLIW-type processor in accordance with one embodiment;

FIG. 3 is a block diagram illustrating the replacing of NOP instructions in an instruction stream of a first program with instructions for a second program in accordance with one embodiment;

FIG. 4 is a flowchart illustrating a method for replacing NOP instructions in a first set of instructions for a first program with processor instructions from a second set of instructions for a second program using a compiler in accordance with one embodiment;

FIG. 5 is a flowchart illustrating a method for replacing NOP instructions in a first set of instructions for a first program with processor instructions from a second set of instructions for a second program using a processor in accordance with one embodiment;

FIG. 6 is a functional block diagram illustrating a processor having a first set of registers for use by a first program and a second set of registers for use by a second program in accordance with one embodiment;

FIG. 7 is a flowchart illustrating a method for replacing NOP processor instructions in a first set of instructions for a first program with processor instructions from a second set of instructions for a data integrity and security program using a compiler in accordance with one embodiment;

FIG. 8 is a flowchart illustrating a method for initializing the execution of a security program in accordance with one embodiment; and

FIG. 9 is a flowchart illustrating a method for executing processor instructions for a data integrity and security program in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more preferred embodiments of the invention are described below. It should be noted that these and any other embodiments described below are exemplary and are intended to be illustrative of the invention rather than limiting.

Broadly speaking, the invention comprises systems and methods for replacing no-operation (NOP) instructions in a first program with instructions for a second program. The replacement enables execution of the second program during execution of the first program without using significant (if any) processing resources that are usable by the first program. “Usable” is used here to refer to resources that are currently usable by the first program, rather than resources that are ever usable by the first program. Thus, for example, processing resources (e.g., registers) that are unused by the first program because of a NOP instruction are considered, for the purposes of this disclosure, to be unusable, even though they may be usable by the first program before or after the NOP instruction is processed.

It should be noted that the term “NOP instructions” is intended to include any means by which an instruction communicates to a processor not to perform any action during that clock cycle. For example, a NOP instruction may be represented by a particular binary number, or it may be communicated to the processor by setting a specific register to a specific value, or by other similar methods. A NOP instruction may also simply be an unused cycle of processing time. It should also be noted that “program,” as used herein, is intended to refer to a set of instructions that form a computer program or application and that exist in a form which may include NOP instructions. For example, source code which is written by a programmer is actually an abstraction of the instructions that are actually executed by a computer and does not include NOP instructions. Compiled or executable code, however, consists of lower-level (e.g., machine-language) instructions that are actually executed by the computer to perform the functions of the program. Thus, references in the present disclosure to instructions of a particular program should be construed to refer to these lower-level streams of instructions.

In one embodiment, execution of the second set of processor instructions does not use any processing resources that are usable by the first set of processor instructions. The execution of the combined set of instructions may be accomplished, for example, without switching execution contexts, and without the overhead associated with switching contexts. Likewise, in one embodiment, execution of the second set of processor instructions may be accomplished without using registers that are usable by the first set of processor instructions.

In another embodiment, certain processing resources, such as one or more processor registers, may be allocated to the execution of the second program preventing the second program from using resources usable by the first (and main) program.

In one embodiment, if only limited processing resources are available to the second set of processor instructions, one or more restrictions may be imposed on the choice of a second program. For example, the second program may be restricted to: programs having program instructions that are mostly independent of each other; programs having small code size; programs having a small and limited state machine; programs for which the majority of processing can be performed in a single routine; or programs whose execution requires only a small number of registers. Data integrity check program, security check programs, processor diagnostic programs, system diagnostic programs, data encryption/decryption programs, and data compression/decompression programs are some examples of such programs.

The replacing of the NOP instructions may be performed at several stages, ranging from compilation to execution of the program by a processor. In one embodiment, the NOP instructions are replaced by a compiler during compilation of the first and second set of processor instructions. Alternatively, the replacing may be performed by a processor after the processor receives the compiled instructions for the first and second programs. In one embodiment, the instructions for the second program may be predetermined and stored in a memory location (for example, a ROM) accessible by the processor. The processor can then access the instructions when the processor determines enough NOP instructions are available to be replaced by the instructions for the second program.

In other embodiments, the replacing may be performed after compilation and before execution of the instructions either manually by the user or by another tool configured to perform the replacing. In yet other embodiments, the replacing may be performed in multiple stages, and in addition, the NOP instructions may be replaced with instructions from more than one program.

It should be noted that the term “processor” is intended to include many different types of processors that are configured to receive NOP instructions. For example, the processor may be a simple, single-pipeline, single-issue processor, or the processor may be a very long instruction word (VLIW)-type processor, or the processor may be a multi-issue processor. The term “processor” may also refer to a group of processors such as a group of similar processors operating in parallel or a group of dissimilar processors operating together. In addition, the term “processor” may refer a general-purpose processor or a special-purpose processor such as a digital signal processor (DSP).

The various embodiments of the present invention may provide a number of advantages over prior art. Processing resources otherwise wasted by NOP instructions are utilized by replacing the NOP instructions with instructions from a second program or programs without significantly (if at all) interfering with the execution of the first set of processor instructions. Execution of the second set of processor instructions may be accomplished, for example, without changing execution contexts and without using any registers that are usable by the first set of processor instructions. Similar advantages may be provided in other embodiments involving other processes for replacing NOP instructions in a first set of processor instructions with instructions from a second set of processor instructions.

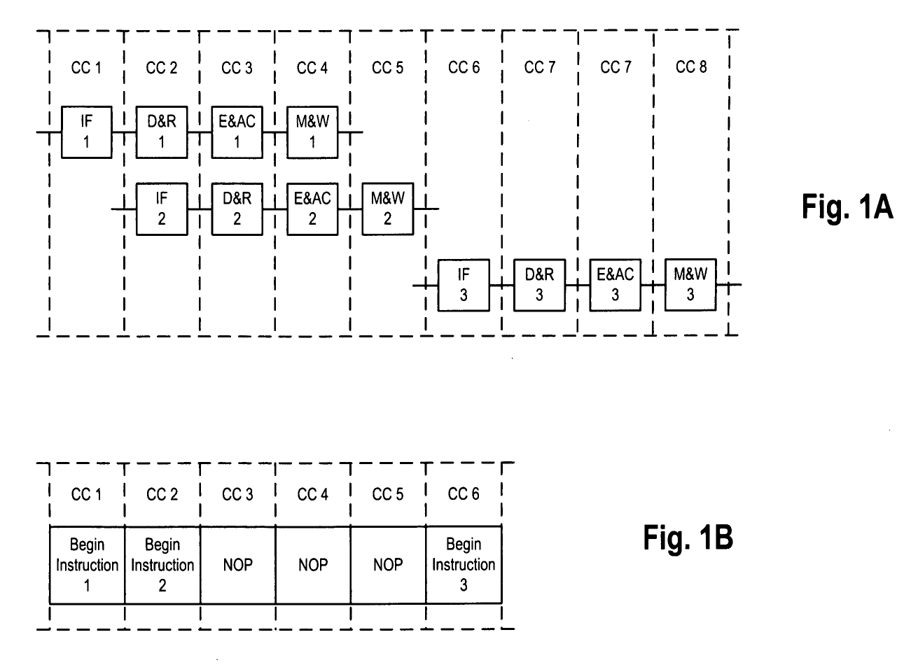

Referring to FIG. 1A, a block diagram illustrating the processing sequence of a first set of instructions by a pipelined processor in accordance with one embodiment is shown. The pipelined processor in the example shown in FIG. 1A processes instructions in four execution stages (i.e., the processor has a four-stage pipeline). Each row in the figure corresponds to the data path of one instruction, and each column corresponds to a different clock cycle (represented by CC 1, CC 2, etc.). For this example, it is assumed that the first and second instructions are independent of each other, and that the third instruction is dependent on the second instruction. That is, execution of the second instruction must end and a corresponding result must be obtained before the execution of the third instruction can begin.

As stated above, the processor in this example is assumed to have four execution stages. These stages include the instruction fetch (IF) stage, the decode and read (D&R) stage, the execution and address calculation (E&AC) stage, and the memory and writeback (M&W) stage. At the first stage (IF), the instruction to be executed is read or “fetched” from memory. At the second stage (D&R), the instruction is decoded. In other words, a value in specific field of the instruction is read and the corresponding operation (e.g., add or multiply) is identified. The data needed to perform the operation is also read from the registers in this stage. At the third stage (E&AC), the operation identified in the instruction is executed and addresses that are needed are calculated. Finally, at the fourth stage (M&W), the processed data is stored into the registers and possibly also written back into memory.

According to this example, during the first clock cycle (CC 1), execution of the first instruction begins at the first stage (IF 1). At the second clock cycle (CC 2), the first instruction advances to the second stage (D&R 1), and execution of the second instruction begins at the first stage (IF 2). At the third clock cycle (CC 3), the first instruction advances to the third stage of execution (E&AC 1), and the second instruction advances to the second stage of execution (D&R 2), leaving the first stage open for a third instruction. Due to the dependency between the third and second instructions, however, processing of the third instruction cannot begin until the processing of the second instruction has ended. Thus, processing of the third instruction is delayed. Processing of the second instruction ends at the fifth clock (CC 5), enabling execution of the third instruction to begin at the sixth (CC 6) clock cycle. Processing of the third instruction ends at the ninth clock cycle (CC 9). The execution of subsequent instructions is similarly arranged. Namely, processing of a subsequent instruction begins on the next clock cycle at the first stage unless a dependency exists between the next instruction and an instruction that is still being processed in the pipeline. In the cases where a dependency exists, processing of the subsequent instruction is delayed accordingly.

Referring to FIG. 1B, a block diagram illustrating the insertion of NOP instructions into the instruction stream of a pipelined processor in accordance with the previous example is shown. Continuing the example shown in FIG. 1A, FIG. 1B illustrates where and why NOP instructions are needed in the instruction stream for the program. The first and second instructions can simply occupy the first and second positions in the instruction stream (corresponding to the first and second clock cycles). However, as was shown in FIG. 1A, processing of the third instruction cannot begin until the sixth clock cycle (CC6). Accordingly, in order to maintain proper spacing (timing) between the instructions three NOP instructions must be inserted into the instruction stream at the third, fourth, and fifth clock cycles. During those clock cycles no new instructions enter the processor and the processor is instructed to remain idle. As a result, the processor is underutilized during the three clock cycles corresponding to the NOP instructions.

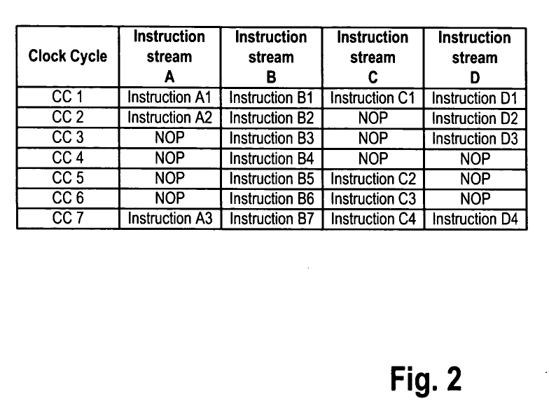

FIG. 2 is a table illustrating the inclusion of NOP instructions into the instruction streams of a VLIW-type processor in accordance with one embodiment. A VLIW-type processor is a processor that is configured to accept a long word instruction containing multiple instructions. Accordingly, a VLIW-type processor can accept and process multiple streams of instructions in parallel. These streams of instructions are typically formed at the processor, which fetches a single stream of instructions from memory and assigns individual instructions to the different slots in a VLIW instruction word, thereby forming what are effectively different streams of instructions.

The VLIW processor shown in this example can accept four streams of instructions (instruction sets A, B, C, and D). Typically, the instructions in the different streams of VLIW processors must be of different types, and as a result, type A instructions can only be included in the A instruction stream, type B instructions can only be included in the B instruction stream, etc. For the same reasons discussed above, for pipelined processors, NOP instructions need to be inserted in the instruction streams to ensure proper spacing (timing) between dependent instructions.

Optimization of VLIW instructions typically is not as effective as optimization of a single stream of instructions (i.e., a stream that is one instruction wide.) This results, at least in part, from the fact that particular types of instructions are constrained to be included in ones of the instruction streams that can accept the respective types of instructions. Therefore, during optimization, instructions typically cannot be migrated across instruction streams to replace NOP instructions. For example, the NOP instructions in instruction stream A can only be replaced with instructions of the same type. The same is true of the other streams of instructions as well. As a result, even after optimization, VLIW processors may have a relatively high number of NOP instructions.

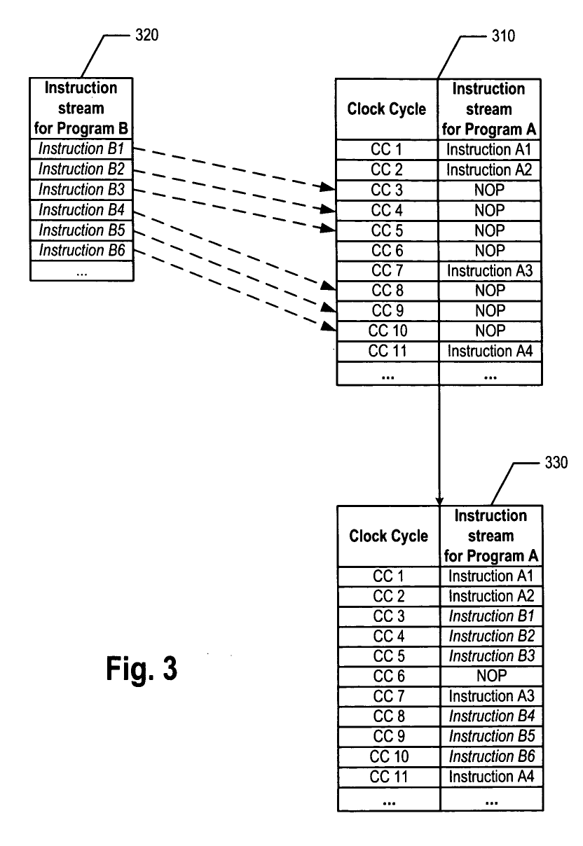

Referring to FIG. 3, a block diagram illustrating the replacing of NOP instructions in an instruction stream of a first program with instructions for a second program in accordance with one embodiment is shown. Table 310 shows the execution order for a first set of instructions (instructions A1-A4 and NOP instructions) for a first program. This order may be determined, for example, by a compiler. The instruction stream includes NOP instructions inserted by the compiler to ensure proper spacing of dependent instructions. In one embodiment, the compiler (or other similar tool) may also have applied optimization algorithms to the instruction stream in an attempt to minimize the number of NOP instructions and thus reduce the amount of wasted processing resources.

Table 320 shows the execution order for a second set of instructions (instructions B1-B6) for a second program as also determined, for example, by a compiler. In order to reduce the amount of wasted processing resources (corresponding to the NOP instructions in the first set of instructions,) instructions from the second stream of instructions are inserted into the first instruction stream by replacing one or more of the NOP instructions. A combined set of instructions is thereby formed, as shown in Table 330.

It should be noted that it may be necessary to replace the NOP instructions with other instructions in blocks. That is, if two or more of the instructions of the second set must be executed consecutively, it will be necessary to replace a corresponding number of consecutive NOP instructions. For example, an instruction which adds two values may have to follow a pair of instructions which loaded these two values into registers. Thus, it may be necessary to identify three consecutive NOP instructions in the first set of instructions which can be replaced by these three instructions from the second set of instructions.

The same may be true of other processing resources as well. For instance, if an instruction in the second set of instructions requires the use of a register, it may be necessary to ensure that a register is available (i.e., the register is not being used by instructions in the first set of instructions) before a NOP instruction in the first set is replaced with this instruction. Because of these constraints, it may be the case that not all of the NOP instructions in the first set of instructions are replaced with instructions from the second instruction stream.

As mentioned above, the replacement of the NOP instructions in the first program with instructions of the second program may occur at different stages. Because NOP instructions are generated in the process of compiling the source code to form machine-language (executable) code, this is the first opportunity to replace the NOP instructions. The NOP instructions may be replaced at compile-time with instructions of a second program that are generated at the same time, or that were previously compiled. At the other end of the spectrum, the NOP instructions may be replaced at run-time, just before they are actually executed by the processor. In this case, the processor receives the instruction streams corresponding to the first and second programs, determines which of the NOP instructions in the first program can be replaced with instructions of the second program, and performs the replacement. All or part of this process can also be performed at various times between compilation and execution of the instructions.

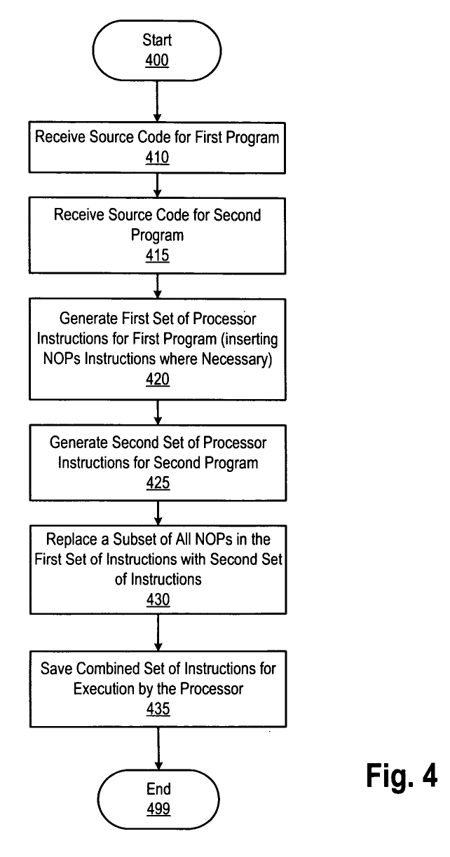

Referring to FIG. 4, a flowchart illustrating a method for replacing NOP processor instructions in a first program with processor instructions from a second program using a compiler is shown.

Processing begins (block 400) and the source code for the first program is received by the compiler (block 410). The source code for the second program is also received by the compiler (block 415). The source code for the first and second programs may be, for example, a higher level language such as C, C++, Visual Basic, or the like, that the compiler is configured to translate into processor instructions.

The first set of processor instructions for the first program is then generated by the compiler (block 420.) In one embodiment, after generating the processor instructions corresponding to the high-level instructions, the compiler inserts NOP instructions where necessary to ensure proper spacing between dependent instructions. In addition, the compiler may optimize the instruction order in order to reduce the number of NOP instructions in the instruction stream.

The second set of processor instructions for the second program is generated by the compiler using the received second source code (block 425.) In one embodiment, the compiler may receive one or the other of the first and second sets of processor instructions instead of generating both sets of processor instructions. The first or second sets of processor instructions may be generated, for example, by a different compiler, or they may have been previously compiled and stored (then retrieved for use in replacing the NOP instructions of the first program.)

The instructions in the second set of processor instructions are then inserted into the first set of processor instructions by replacing one or more consecutive NOP instructions with the instructions from the second set (block 430.) In one embodiment, additional instructions from additional programs may be inserted into the first set of processor instructions. In one embodiment, the compiler may determine whether to replace NOP instructions by comparing the number of slots required by the second set of processor instructions with the number of available NOP slots. The combined set of processor instructions is then saved to a memory location (block 435) from which they can later be retrieved for execution by a processor.

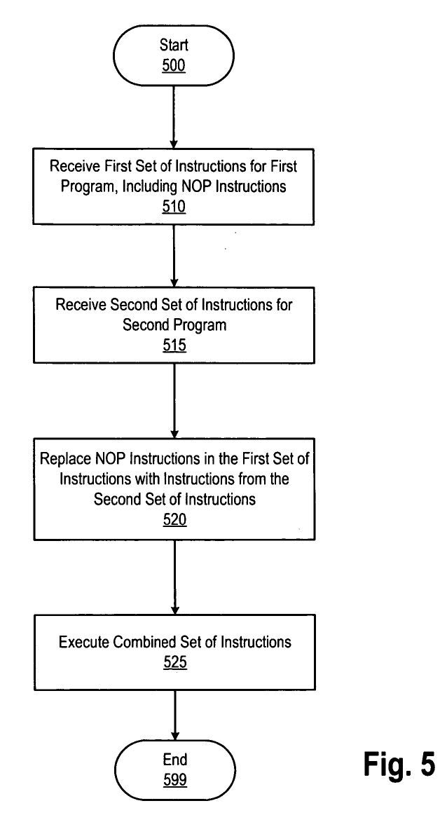

FIG. 4 illustrates an embodiment of a method that is implemented at compile-time. FIG. 5, on the other hand, illustrates a similar method that is implemented at run-time.

Referring to FIG. 5, a flowchart illustrating a method for replacing NOP processor instructions in a first set of instructions for a first program with processor instructions from a second set of instructions using a processor is shown.

Processing begins (block 500,) and the processor receives a first set of processor instructions for a first program (block 510.) The first set of processor instructions may include one or more NOP instructions that are inserted to ensure proper spacing between dependent instructions. In one embodiment, the first set of processor instructions may be retrieved from a memory location, such as a section of RAM in which the first program is stored.

A second set of processor instructions for a second program is also received by the processor (block 515.) In one embodiment, the second set of processor instructions may also be retrieved from a memory location at which the second program has been stored. In another embodiment, the second set of processor instructions may be received from a ROM coupled to the processor. In yet another embodiment, the second set of processor instructions may be encoded in the processor as a set of microcoded instructions (much like a ROM but inside the processor itself).

The processor then replaces NOP instructions from the first set of processor instructions with processor instructions from the second of set of processor instructions (block 520.) It should be noted that it is not necessary for the processor to receive all of the instructions in the first and second sets before beginning to perform the replacement of the instructions. In fact, it will typically be the case that only a subset of each set of instructions will be handled by the processor at a given time, and the replacement of instructions will be performed just before the instructions are executed by the processor. The processor can identify replacement candidate NOP instructions (or series of NOP instructions) and perform the replacements in much the same way as in a compiler, except that the replacement is performed at run-time instead of compile-time.

In one embodiment, the processor may be configured to determine whether the replacement of NOP instructions with instructions from the second set of processor instructions would interfere with the execution of the first set of processor instructions, and only perform the replacement if this would not interfere with the execution of the first set of processor instructions.

The combined set of processor instructions is then executed by the processor (block 525.) The instructions from the second set of instructions are interleaved with the instructions from the first set of instructions, and the second program executes simultaneously with the first program.

In one embodiment, all of the processor's resources are available to the first program, and these resources are used by instructions of the second program only if they are unused by the first program. In another embodiment, processor may automatically use hidden registers like those which are already reserved for microcode execution. In another embodiment, the processor may add a small number of registers that are reserved for the execution of the second program. The additional registers may make it easier to schedule execution of the instructions of the second set without interfering with the execution of the first set of processor instructions.

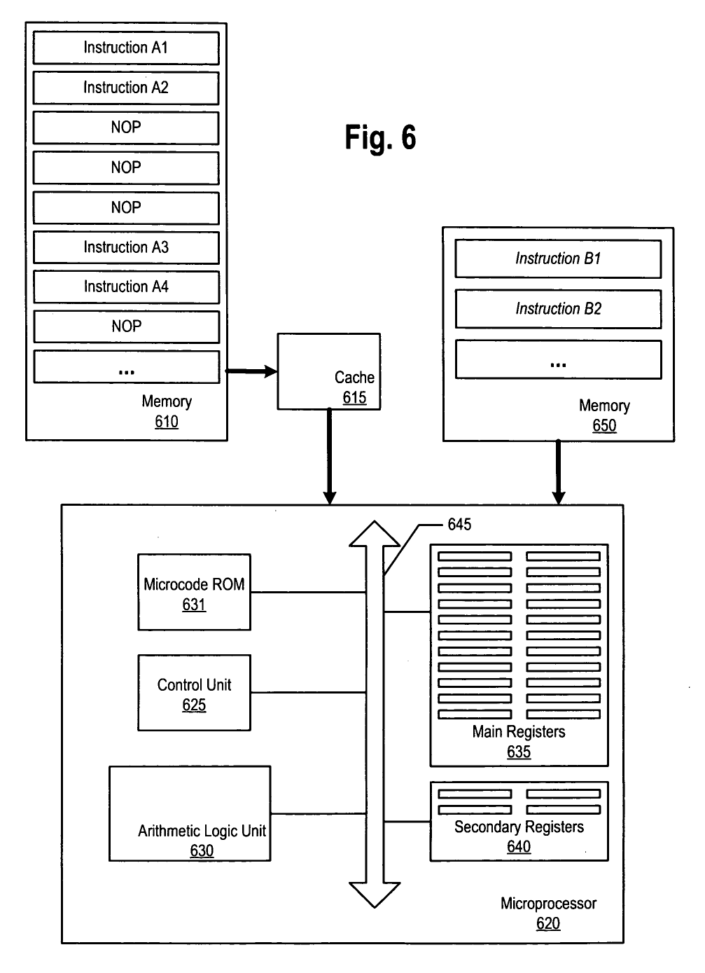

Referring to FIG. 6, a functional block diagram illustrating a processor having a first set of registers for use by a first program and a second set of registers for use by a second program in accordance with one embodiment is shown. (As mentioned above, an alternative embodiment makes all of the registers and other processor resources available to the first program.) Microprocessor 620 represents a typical processor which, in this embodiment, is configured to retrieve processor instructions from a first memory 610, as well as a second memory 650. In this embodiment, processor instructions from memory 610 are also stored in cache memory 615 in accordance with the cache replacement policy.

As shown in FIG. 6, microprocessor 620 includes a control unit 625 that includes hardware instruction logic configured to decode and monitor the execution of the processor instructions. Control unit 625 may also control the interfaces of devices inside microprocessor 620 and the interfaces between microprocessor 620 and various external devices. Microprocessor 620 includes arithmetic logic unit (ALU) 630, which is configured to perform logic and arithmetic operations within microprocessor 620. A microcode ROM 631 is included in this embodiment to store microcode instructions that can be executed by microprocessor 620. Microprocessor 620 also includes internal bus 645, which is configured to transfer data between the various components of microprocessor 620. In alternative embodiments, the microprocessor may or may not include the components referred to above, as the components are only intended to be exemplary of a typical processor.

In this embodiment, microprocessor 620 includes two sets of registers: main registers 635; and secondary registers 640. Main registers 635 are reserved exclusively in this embodiment for the execution of instructions from the first set of processor instructions received from memory 610. Secondary registers 640 are reserved exclusively for the execution of instructions from the second set of processor instructions received from memory 650. Reserving a set of registers, such as secondary registers 640, for the exclusive use of the second set of instructions helps to ensure that the processing/execution of the second set of processor instructions will not interfere with (i.e., take resources away from) the first set of instructions. In other embodiments, the registers may be allocated in a different manner. Other types of processing resources may also be allocated as reserved or shared resources in various embodiments.

In one embodiment, microprocessor 620 is configured to receive the first set of processor instructions from memory 610 and the second set of processor instructions from memory 650. Microprocessor 620 is also configured to examine the incoming stream of the first set of processor instructions and to search the stream for NOP instructions. Microprocessor 620 is further configured to replace one or more of the NOP instructions in the first set of processor instructions with instructions from the second set of processor instructions (in order to form a combined set of processor instructions) according to a predetermined algorithm.

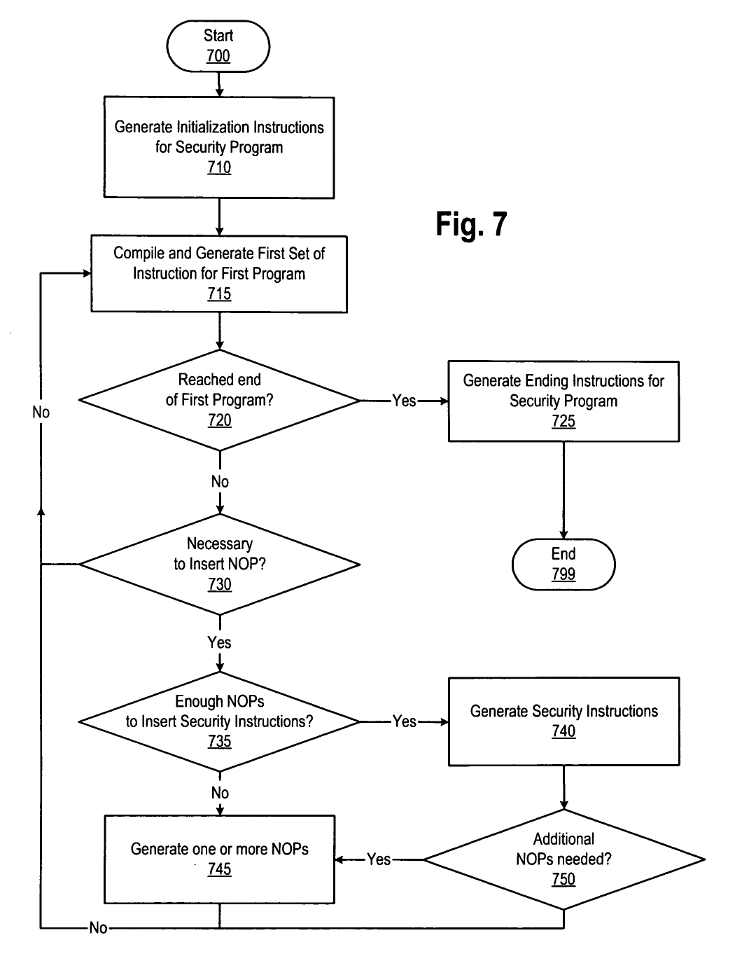

As noted above, the second program (the instructions of which are inserted in place of NOP instructions in the first program) may be of various types. For example, in one embodiment, the second program may be designed to check code and data integrity (i.e., security check) during run-time. Depending upon the type of the second program, it may be advantageous to choose a particular implementation of the invention that is appropriate to the program's type. For example, if the second program is designed to ensure the security of the first program, it may be advantageous to combine the two programs at compile-time. This may be accomplished as shown in FIG. 7.

Referring to FIG. 7, a flowchart illustrating a method for replacing NOP processor instructions in a first set of instructions (corresponding to a first program) with processor instructions from a second set of instructions (corresponding to a second, security program) by a compiler is shown. The security program may be configured, for example, to monitor the proper execution of the first set of processor instructions by the processor. The method of replacing NOP instructions from the first program with processor instructions for the security program is described merely as an example.

Processing begins (block 700) and initialization instructions for the security program are generated (block 710.) The security program is initialized with values corresponding to the instructions of the main, first program that are about to execute. Processing continues with the compilation of the first (main) program into a first set of processor instructions (block 715.)

A determination is then made as to whether the compiler has finished compiling the first program (decision block 720.) If the compiler has finished compiling the first program, the method branches to the “yes” branch, whereupon the ending instructions for the security code are generated (block 725.) Processing subsequently ends (block 799.)

Returning to decision block 720, if the compiler has not finished compiling the first program, the method branches to the “no” branch, whereupon a determination is made as to whether it would be necessary to insert one or more NOP instructions into the generated, first set of processor instructions (block 730.) It may be necessary to insert NOP instructions, for example, to ensure proper spacing between dependent instructions. If it is determined that it is not necessary to insert NOP instructions into the first set of processor instructions, the method branches to the “no” branch, whereupon processing returns to block 715, where additional portions of the first program are compiled to generate additional processor instructions.

On the other hand, if it is determined that one or more NOP instructions need to be inserted into the first set of processor instructions (decision block 730,) the method branches to the “yes” branch, whereupon a determination is made as to whether the number of NOP instructions to be inserted is enough to accommodate processor instructions for the security program (decision block 735.) If the number of NOP instructions is enough, the method branches to the “yes” branch, whereupon the compiler generates the security instructions and then appends the instructions to the first set of processor instructions (block 740.)

A determination is then made as to whether additional NOP instructions need to be generated for padding (decision block 750.) Additional NOP instructions may need to be generated, for example, if the number of generated security instructions was less than the required number of NOP instructions. If no additional NOP instructions are required, the method branches to the “no” branch, whereupon processing returns to block 715. Then, additional portions of the first program are compiled to generate additional processor instructions. If additional NOP instructions are required, the method branches to the “yes” branch whereupon processing continues (block 745.)

Returning to decision block 735, if there are not enough NOP instructions to insert security code, the method branches to the “no” branch, whereupon the required one or more NOP instructions are generated (block 745.) Processing subsequently returns to block 715 where additional portions of the first program are compiled to generate additional processor instructions. This looping continues until all of the first program has been compiled.

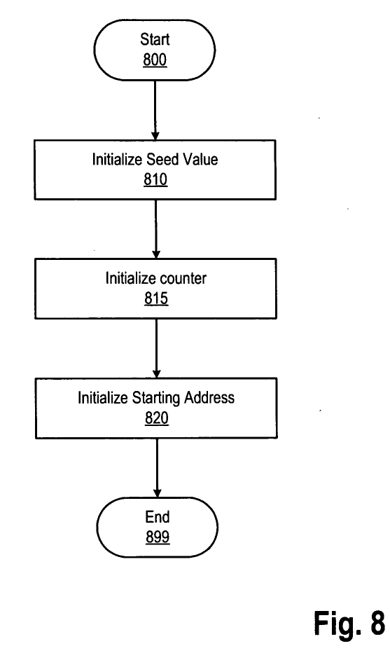

Referring to FIG. 8, a flowchart illustrating a method for initializing the execution of a security program is shown. Processing begins (block 800,) and the seed value is initialized to a value corresponding to the main code being executed at the time (block 810.) The counter is then initialized (block 815,) and the starting address in the main program is initialized (block 820.) The security program is initialized with values corresponding to the initial execution of the first set of processor instructions for the first program. Processing then ends (block 899.)

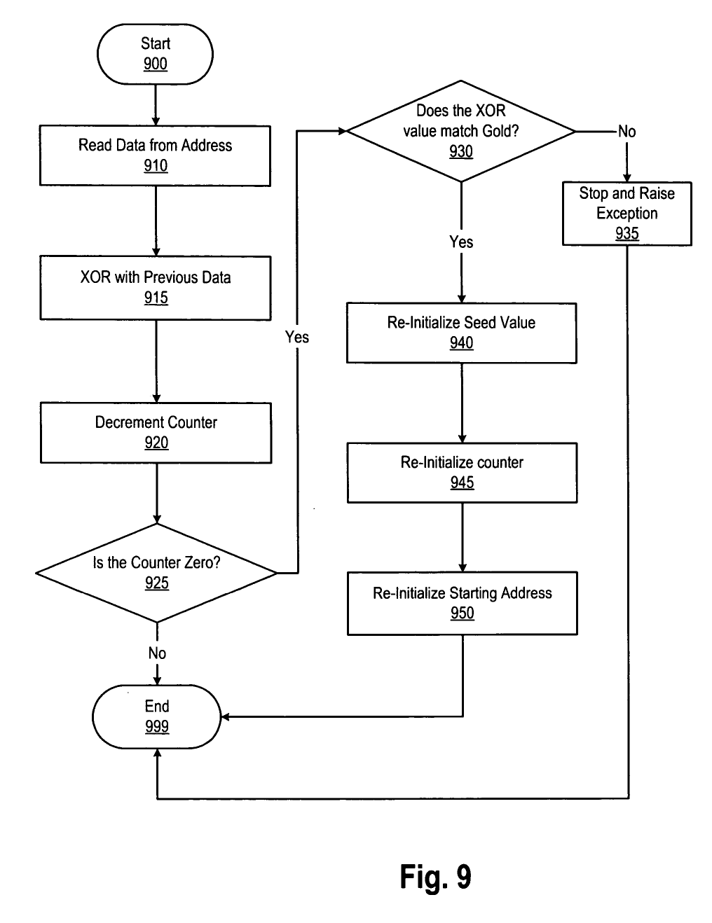

Referring to FIG. 9, a flowchart illustrating a method for executing security instructions to monitor the execution of the main program is shown. The security program monitors execution of the first (main) program to ensure the first program's proper execution. Processing begins (block 900,) whereupon data associated with the execution of the first program is read from the initialization address (block 910.) An exclusive or (XOR) operation is then performed on the read data and on previously read data (block 915) to obtain a result that is to be compared to a “gold” value later, during execution. This comparison will be performed to determine whether execution is proceeding properly. The counter is then decremented to track the number of times the XOR operation has been performed (block 920.) The counter corresponds to the number of times the XOR operation will be performed between comparisons to the “gold” value.

A determination is then made as to whether the counter has reached zero (decision block 925.) If the counter has not yet reached zero, the method branches to the “no” branch, whereupon processing ends (block 999.) On the other hand, if the counter has reached zero, the method branches to the “yes” branch, whereupon another determination is made as to whether the result from the XOR operation matches the “gold” value (decision block 930.) If the XOR result does not match the “gold” value, the method branches to the “no” branch, whereupon execution is halted and an exception is raised (block 935,) indicating a problem with the execution of the first program. Processing subsequently returns to the calling routine (block 935.) On the other hand, if the XOR result matches the “gold” value, the method branches to the “yes” branch, whereupon the seed value is re-initialized to correspond to the next set of instructions to be executed (block 940.) The counter is then re-initialized (block 945,) and the starting address is re-initialized (block 950.) Processing subsequently ends (block 999.)

It should be understood that, while the present invention has been described with reference to particular embodiments, these embodiments are illustrative, and the scope of the invention is not limited to these embodiments. Many variations, modifications, additions and improvements to the embodiments described above are possible. It is contemplated that these variations, modifications, additions and improvements fall within the scope of the invention as detailed within the claims.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with general purpose processors, digital signal processors (DSPs), application specific integrated circuits (ASICs), field programmable gate arrays (FPGAs) or other programmable logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, multiple processors with heterogeneous instruction sets and/or architectures, or any other such configuration. A processor may further include emulators and simulators of the devices.

The steps of a method or algorithm described in connection with the embodiments disclosed herein may be embodied directly in hardware, in a software module executable by a processor, or in a combination of the two. A software module may reside in RAM memory, flash memory, ROM memory, EPROM memory, EEPROM memory, registers, hard disk, a removable disk, a CD-ROM, or any other form of computer-readable storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It should be understood that “computer” and “computer system,” as used herein, are intended to include any type of data processing system capable of performing the functions described herein. “Computer-readable media,” as used herein, refers to any medium that can store program instructions that can be executed by a computer, and includes floppy disks, hard disk drives, CD-ROMs, DVD-ROMs, RAM, ROM, PROM, EPROM, EEPROM, flash memory, memory logic constructed from programmable gates (e.g. FPGA), DASD arrays, magnetic tapes, floppy diskettes, optical storage devices, network (both wired and wireless) storage devices (e.g., SAN or NAS,) and the like.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

What is claimed is:

1. A method comprising:
providing a first program and a second program;
wherein the first program comprises a first set of instructions for execution by a processor, and wherein the first set of instructions includes one or more NOP instructions, and
wherein the second program comprises a second set of instructions for execution by the processor; and
enabling execution of instructions from the second set of instructions in place of the NOP instructions in the first set of instructions.

2. The method of claim 1, further comprising enabling execution of instructions from the second set of instructions in place of the NOP instructions in the first set of instructions without switching execution contexts.

3. The method of claim 1, wherein the second program is selected from the group consisting of: data integrity check programs; security check programs; processor diagnostics programs; system diagnostics programs; data encryption/decryption programs; and data compression/decompression programs.

4. The method of claim 1, wherein the first program is independent of the second program.

5. The method of claim 1, further comprising allocating one or more registers of the processor executing the first and second programs to the execution of the second program.

6. The method of claim 1, wherein execution of the second program does not use any processing resources that are currently usable by the first program.

7. The method of claim 1, wherein enabling execution of instructions from the second set of instructions in place of the NOP instructions in the first set of instructions comprises replacing the NOPs of the first set of instructions with instructions from the second set of instructions.

8. The method of claim 7, wherein replacing the NOPs of the first set of instructions with instructions from the second set of instructions is performed during compilation of the first program.

9. The method of claim 7, wherein replacing the NOPs of the first set of instructions with instructions from the second set of instructions is performed during execution of the first program.

10. The method of claim 7, wherein replacing the NOPs of the first set of instructions with instructions from the second set of instructions is performed after compilation of the first program and before execution of the first program.

11. The method of claim 7, further comprising:
determining whether a first number of instructions of the second program must be executed consecutively;
identifying a series of consecutive NOP instructions in the first program;
determining whether the series of consecutive NOP instructions includes at least the first number of NOP instructions; and
replacing the first number of NOP instructions with the first number of instructions of the second program if the series of consecutive NOP instructions includes at least the first number of NOP instructions.

12. A system comprising:
a processor
one or more memories coupled to the processor
wherein the processor is configured to
retrieve instructions of a first program and instructions of a second program from the one or more memories,
identify one or more NOP instructions in the instructions of the first program,
replace one or more of the NOP instructions with instructions of the second program to form a combined instruction stream, and
execute the combined instruction stream.

13. The system of claim 12, wherein the processor is configured to execute the combined instruction stream without switching contexts.

14. The system of claim 12, wherein the one or more memories include a first memory and a second memory which is separate from the first memory, and wherein the instructions of the first program are stored in the first memory and the instructions of the second program are stored in the second memory.

15. The system of claim 14, wherein the second memory comprises a read-only memory (ROM).

16. The system of claim 12, further comprising a plurality of registers configured to store data used in execution of the instructions of the first and second programs.

17. The system of claim 16, wherein a first portion of the registers is allocated exclusively to execution of instructions of the first program and a second portion of the registers is allocated exclusively to execution of instructions of the second program.

18. The system of claim 12, wherein the processor is configured to make processing resources available for execution of the instructions of the second program only to the extent that the processing resources are not currently usable for execution of the instructions of the first program.

19. A computer-readable medium containing one or more instructions configured to cause a computer to perform the method comprising:
receiving a first program and a second program;
identifying one or more NOP instructions in the instructions of the first program; and
replacing one or more of the NOP instructions with instructions of the second program to form a combined instruction stream.

20. The computer-readable medium of claim 19, wherein the method further comprises compiling at least one of the first and second programs from source code.

21. The computer-readable medium of claim 19, wherein the method further comprises replacing one or more of the NOP instructions with instructions of the second program only if replacing the one or more of the NOP instructions with instructions of the second program does not cause interference with execution of the first program.

22. The computer-readable medium of claim 21, wherein the method further comprises replacing one or more of the NOP instructions with instructions of the second program only if replacing the one or more of the NOP instructions with instructions of the second program does not require any processing resources that would otherwise be used by the first program.

23. The computer-readable medium of claim 19, wherein the method further comprises:
determining whether a first number of instructions of the second program must be executed consecutively;
identifying a series of consecutive NOP instructions in the first program;
determining whether the series of consecutive NOP instructions includes at least the first number of NOP instructions; and
replacing the first number of NOP instructions with the first number of instructions of the second program if the series of consecutive NOP instructions includes at least the first number of NOP instructions.
